(19) United States
(12) Patent Application Publication
(10) Pub. No.: US 2018/0075327 A1
(43) Pub. Date: Mar. 15, 2018

(54) AUTOMATED LOCATION BASED COMPARATIVE MARKET ANALYSIS

(71) Applicants: Jon Rubinton, Naples, FL (US); Daniel Sexton, Naples, FL (US)

(72) Inventors: Jon Rubinton, Naples, FL (US); Daniel Sexton, Naples, FL (US)

(73) Assignee: RealtyMaps, LLC, Naples, FL (US)

(21) Appl. No.: 15/703,009

(22) Filed: Sep. 13, 2017

Related U.S. Application Data
(60) Provisional application No. 62/416,076, filed on Nov. 1, 2016.
(60) Provisional application No. 62/397,974, filed on Sep. 22, 2016.
(60) Provisional application No. 62/397,839, filed on Sep. 21, 2016.
(60) Provisional application No. 62/394,706, filed on Sep. 14, 2016.
(60) Provisional application No. 62/394,380, filed on Sep. 14, 2016.

(51) Int. Cl. G06K 15/02; G06F 3/12; G06Q 30/02; G06Q 50/16; G06F 17/30; H04W 4/02

(52) U.S. Cl. CPC G06K 15/1819; G06F 3/1206; G06F 3/1292; H04W 4/021; G06Q 30/0206; G06Q 50/16; G06F 17/30241; G06Q 30/0205

(57) ABSTRACT

The present disclosure relates to an automated controller for generating a comparative market analysis. Based upon a selected point, the controller generates a Boundary associated with the Geospatial designation and a Person associated with the Boundary. More specifically, the present invention includes a print controller that determines a geospatial designation and associates the geospatial designation with a pecuniary value and real estate property attributes.

### CROSS REFERENCE TO RELATED APPLICATIONS

This application claims the benefit of provisional U.S. Patent Application Ser. No. 62/394,380, filed Sep. 14, 2016, and entitled: “Automated Location Based Comparative Market Analysis”; and also, Provisional Application, Ser. No. 62/394,706, filed Sep. 14, 2016 and entitled: “Multi-Jurisdiction Asset Locator And Analysis”; and also, Provisional Application, Ser. No. 62/397,839, filed Sep. 21, 2016 and entitled: “Automated Assessed Property Value Challenge”; and also, Provisional Application, Ser. No. 62/397,974, filed Sep. 22, 2016 and entitled: “Automated Real Property Loan To Value Controller”; and also, Provisional Application, Ser. No. 62/416,076, filed Nov. 1, 2016 and entitled: “Automated Real Property Benchmark Event Automated Communication Generator”. The contents of these heretofore mentioned applications are relied upon and hereby incorporated by reference.

### FIELD OF THE DISCLOSURE

The present disclosure relates to an automated comparative market analysis (“CMA”) generator. More specifically, the present invention includes an automated print controller that receives a user designated geospatial designation and associates the geospatial designation with geographic boundaries and further associates the geographic boundaries with physical attributes and a pecuniary value for the attributes in order to generate a physical artifact including pecuniary value of a property parcel based upon, and specific to, the geographic boundaries and the attributes.

### BACKGROUND OF THE DISCLOSURE

Presently, CMA generation generally is based upon an opinion of a real estate agent or real estate appraiser, acting as a CMA appraiser, supported by subjective selection of a list of properties for sale in an area designated by the real estate agent or real estate appraiser. The CMA appraiser must locate other properties proximate to a property being appraised and subjectively allocate a value to distinguishing features between each property and aspects of a property that impart value to the property. Features may include a size of a lot, improvements to a property, Obvious drawbacks inherent in such a system include the subjective nature of a selection of comparable properties and how much value is associated with a feature of a particular property. In addition, the Appraising person must locate and analyze multiple properties in order to subjectively ascertain which properties to include in a CMA and a relative weight of a value of each selected comparable property.

### SUMMARY OF THE DISCLOSURE

Accordingly, the present disclosure relates to a print controller and methods of operating the print controller to generate a CMA based upon a geospatial designation with boundaries, wherein the geospatial designation with boundaries is associated with physical and intangible attributes and a legal entity (a “person”). A physical artifact, such as a printed hardcopy is generated specific to the geospatial designation and a pecuniary value for the geospatial designation based upon quantified values of designated comparable properties. The physical artifact may include for example, a uniform residential appraisal report form or another Freddie Mac or Fannie Mae form. In some embodiments, the physical artifact may include an image of the geospatial designation, such as a street view image or a satellite or other overhead image.

In some embodiments, data descriptive of multiple features of one or both of: a subject property and one or more comparable properties is aggregated and normalized. In addition, a weight may be allocated to a particular feature for a particular property. The weight may be used in allocating a pecuniary value to the particular feature. In some preferred embodiments, each feature is allocated a predetermined weight that may be adjusted by a user on a property by property basis. For example, a “water front” feature may be allocated a predetermined value for a property that may be adjusted by a user for an ocean front property in a highly desirable area. Non-limiting examples of features may include: size of a parcel, square footage of improvements, number of kitchens, number of bedrooms, number of baths, details of outbuildings, swimming pools, tennis courts, a view, deeded amenities, and location in relation to adjacent attractions. Features may be associated with one or both of a subject property for which a value is calculated or a comparable property.

According to some embodiments of the present invention, a user may be at an initial geographic location, such as on a street front of a property and use a mobile device with a GPS capability to run an app that will capture a GPS location and transmit it to the printer controller.

In another aspect of the present invention, a mobile device may also include an image capture capability and a user may take a picture of a property the user is located on or adjacent to and simultaneously record a GPS location of the user. The user may submit the user's current location and the picture to an automated apparatus practicing the present invention. The automated apparatus may receive the image and the GPS location and identify one or more geospatial designations associated with the location. The geospatial designation, may include, by way of non-limiting example, one or more of: a street address, a property parcel, a neighborhood, a homeowners association, a town, a school district, a congressional district or other geospatial designation associated with the user's current location at the time of image capture.

According to the present invention, a user may select one or more geospatial designations from the list and generate hardcopy artifacts addressed to specific to persons associated with the selected geospatial designations.

Additional embodiments may include definition of geospatial designations based upon an area defined around an initial geographic location, such as by a radius around a point specified as the initial geographic location.

In some additional embodiments of the present invention, methods and apparatus are presented for aggregating, organizing, and layering data according to a relation to a real estate parcel and generating physical artifacts based upon aggregated data. The associated systems allow a user may sort and view parcels based on the layered data. In some embodiments, the layered data may comprise data from a variety of sources, such as, for example, government databases, such as tax or census records; public databases, such as the white pages; or subscription databases, such as a multiple listing service database.

More specifically, the present disclosure describes methods and apparatus for designating a location via a point and associating one or more polygon boundaries encompassing the designated point. The point is used to determine a geospatial designation, the one or more polygons associated with the point are associated with one or more real estate areas, such as properties designated in county parcel records. In additional embodiments, polygons are used to designate other areas of real estate, such as lots designated in a survey or subdivision plat.

The associated systems allow a user to sort and view parcels based on the layered data. In some embodiments, the layered data may comprise data from a variety of sources, such as, for example, government databases, such as tax or census records; public databases, such as the white pages; or subscription databases, such as a multiple listing service database.

The present invention provides apparatus and methods for acquiring and providing information related to a parcel to a user. More specifically, the present disclosure describes a method of acquiring, organizing, and layering data related to a parcel, wherein a user may sort and view parcels based on the layered data. In some embodiments, the layered data may comprise data from a variety of sources, such as, for example, government databases, such as tax or census records; public databases, such as the white pages; or subscription databases, and such as a multiple listing service database.

One general aspect includes a printer controller for generating hardcopy artifacts, the printer controller including: a processor; a main memory in logical communication via a digital bus with the processor, said main memory storing executable software, the executable software operative with the processor. The executable software may cause the printer controller to: receive from a user interaction a selected point associated with a geospatial designation. The printer controller also generates a selection of a polygon associated with a geographic area. The printer controller also generates a boundary for the polygon associated with the geographic area. The printer controller also generates an association of the boundary for the geographic area with a person. The printer controller also determines that the selected point is included within one of the polygon and the boundary. The printer controller also designates a person with contact information including at least an address for receiving a hard copy delivery. The printer controller also accesses a storage of attributes related to the geographic area designated. The printer controller also automatically associates at least one comparable real estate property. The printer controller also accesses attributes descriptive of the at least one comparable real estate property. The printer controller also accesses a pecuniary value associated with the at least one comparable real estate property; and generates a comparative market analysis report including: a template for listing the attributes of the at least one comparable real estate property and respective pecuniary values for each comparable real estate property and a calculated value of the geographic area associated with the selected point. The printer controller also generates a hardcopy artifact including the comparative market analysis report and reference to the Person.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a block diagram of geospatial designation and associated geographic boundaries in the context of a status state and communication strategy.

FIG. 1A illustrates a diagram of a user with a position capture device for capturing a real property asset for which status state may be identified.

FIGS. 1B1-1B3 illustrates a flow chart of method steps that may be used to implement some embodiments of the present invention.

FIG. 1C illustrates a regional map with multiple real property assets and their respective locations identified for a given status state, along with an associated subdivision map of a real property asset.

FIG. 2 illustrates an exemplary position capture device and interactive user interface.

FIG. 3 illustrates a block diagram of a user with a position designation device with directional capability.

FIGS. 4A-4D illustrate a flow diagrams with method steps that made be executed in some implementations of the present invention.

FIG. 5 illustrates a block diagram of a relationship between a geospatial designation and multiple geographic areas.

FIG. 6 illustrates aspects of controller hardware useful for implementing the present invention as a block diagram.

FIG. 7 illustrates an exemplary processing and interface system.

FIG. 8 illustrates a block diagram of an exemplary embodiment of a mobile device.

FIG. 9 illustrates an exemplary CMA table of attributes and pecuniary values that may be included in a CMA report.

FIG. 10 illustrates a valuation section of a Uniform Residential Appraisal Report that may be generated in some implementations of the present invention.

FIGS. 11-12 illustrates aspects that may be generated by the automated controller and included in an interface readable by a user.

### DETAILED DESCRIPTION

The present invention present invention provides an automated Comparative Market Analysis tool printer controller and methods of operating the printer controller to generate physical artifacts based upon a determined geospatial location and one or more sets of boundaries associated with the geospatial location. Each set of boundaries is in turn associated with a person. Upon command, the printer controller will generate an artifact specific to the geospatial location and a person predicated upon a choice of boundaries made by a user. In some embodiments, additional information may be aggregated and associated with one or more of: a geospatial location; a set of boundaries, and a person which may be integrated into the communication artifacts based upon a current state of the real estate property or geospatial designation and the communication strategy. In some embodiments, methods of the invention may further include acquiring, organizing, and layering data related to a set of boundaries, such as a real estate property parcel, wherein a user may sort and view parcels and associated persons based on the layered data.

### Glossary

“Person” as used herein, shall mean an individual, a corporate entity or other entity designated by law as a legal person.

“Communication Strategy” as used herein shall mean a program for generating and sending communication artifacts. The communication strategy can include, for example, a type of communication artifact, a content of one or more messages; a frequency of messages to be sent, an interval of time between communications, designated recipients for the communications or other variables associated with a program for communicating with a person associated with a real estate property.

“Geospatial Designation” as used herein shall mean an identifier of a specific point in relation to a geographic reference. Examples of a Geospatial Designation may include a spatial point system, such as a Cartesian Coordinate or a Polar Coordinate.

“Geospatial Designation Identifier” as used herein shall mean a device capable of identifying a Geospatial Designation, such as a point, in relation to a geographic area. Examples of a Geospatial Designation Identifier may include: a device specifically designed to provide Spatial Coordinates and a direction; an independent Global Positioning System Unit such as a Garmin™ TomTom™ or Magellan™; a smart device such as an iPhone™ or an Android™ phone. Other embodiments may include an Internet Access device such as a Personal Computer (“PC”) and an interactive graphical User Interface.

“Geographic Boundary” as used herein shall include a delineation of one or more Geographic Areas.

“Geographic Area” as used herein shall mean an area of land mass acknowledged by an accepted authority, or a specifically delineated geographic area. By way of non-limiting example, a land mass acknowledged by an accepted authority may include an area with legal boundaries, such as a real estate parcel, a township, a city, a county, a state, a political district, such as a congressional district, a homeowners association or other area acknowledged defined by statute or bylaw. A specifically delineated geographic area may include any area input into a user interface or otherwise defined by a User, such as, all area within a defined distance from a specified point.

“Geopolitical Area” as used herein shall mean an area defined according to a political boundary, such as a township, a county, a voting district, a congressional district, a school district, or other legal boundary.

“Cartesian Coordinate” shall mean two coordinates that locate a point on a plane and measure its distance from either of two intersecting straight-line axes along a line parallel to the other axis.

“Loan to Value” sometimes referred to as “LTV” as used herein shall mean a ratio of an amount due on a mortgage or other lien on a real estate property and a pecuniary value of the property.

“Loan to Value Analysis” as used herein shall mean an automated determination of a ratio of an amount due on a mortgage or other lien on a real estate property and an automatically generated pecuniary value of the property based upon features of an automated comparative market analysis or other automated valuation based upon factors including features of a property.

“Subject Property” as used herein shall mean a real estate property parcel identified via a tax map identification by a taxing authority

“User interface” or “Web interface” is a set of graphical controls through which a user communicates. The user interface includes graphical controls such as button, toolbars, windows, icons, and pop-up menus, which the user can select using a mouse or keyboard to initiate required functions on the user interface.

“Status State” a value for a variable descriptive of a predetermined aspect of a real estate property. Non-limiting examples of a Status State include whether a real estate property is currently listed for sale, sale pending, in contract, seeking funding, in foreclosure, has liens recorded against it, meets a loan to value criteria, has a closing scheduled, is within proximity to another property with a designated state, zoning criteria or other aspect.

“Wireless” includes a communication protocol and hardware capable of digital communication without hardwire connections. Examples of Wireless include: Wireless Application Protocol (“WAP”) mobile or fixed devices, 30, 40, 50, Bluetooth, 802.11, or other types of wireless capability.

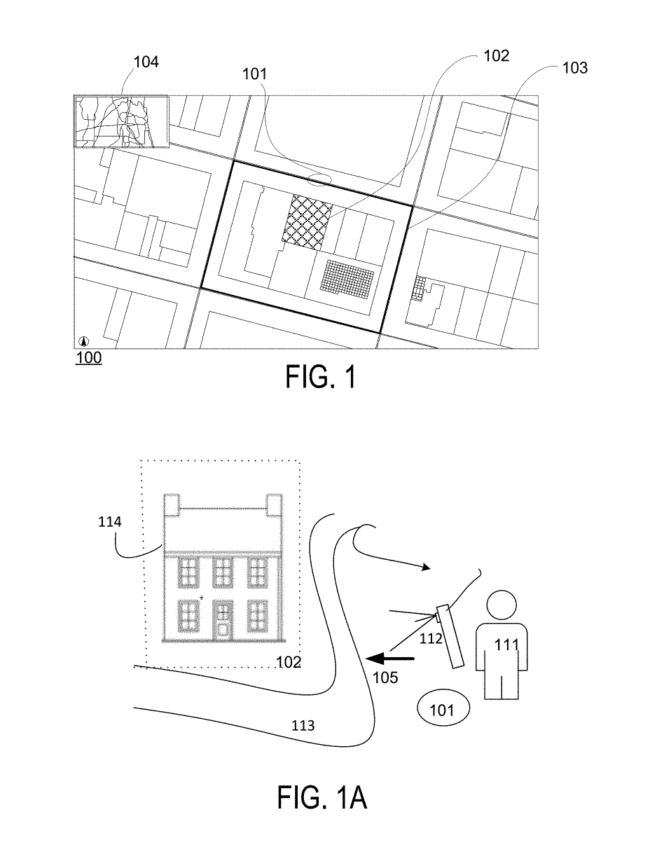

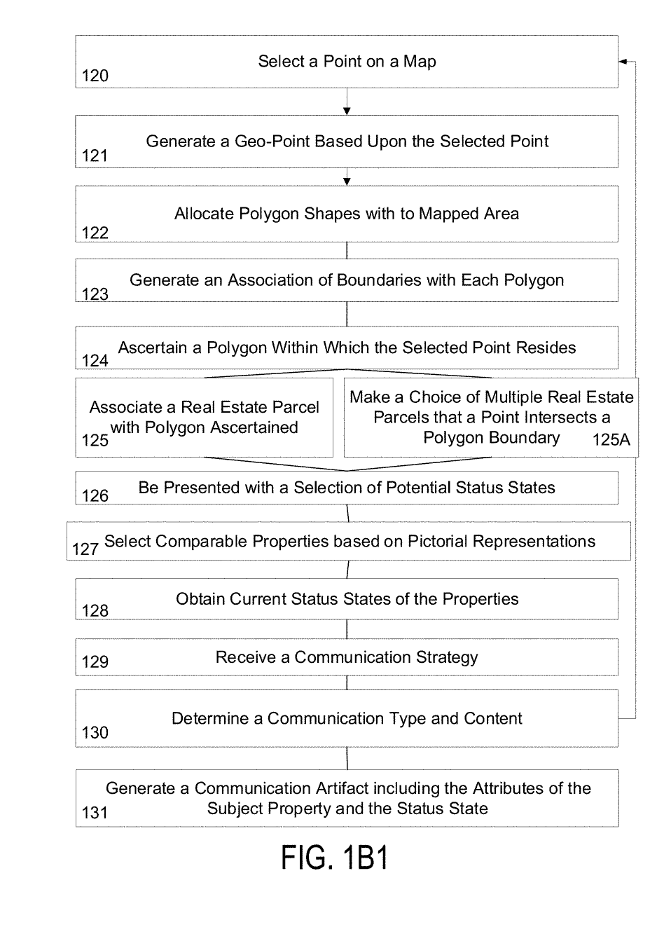

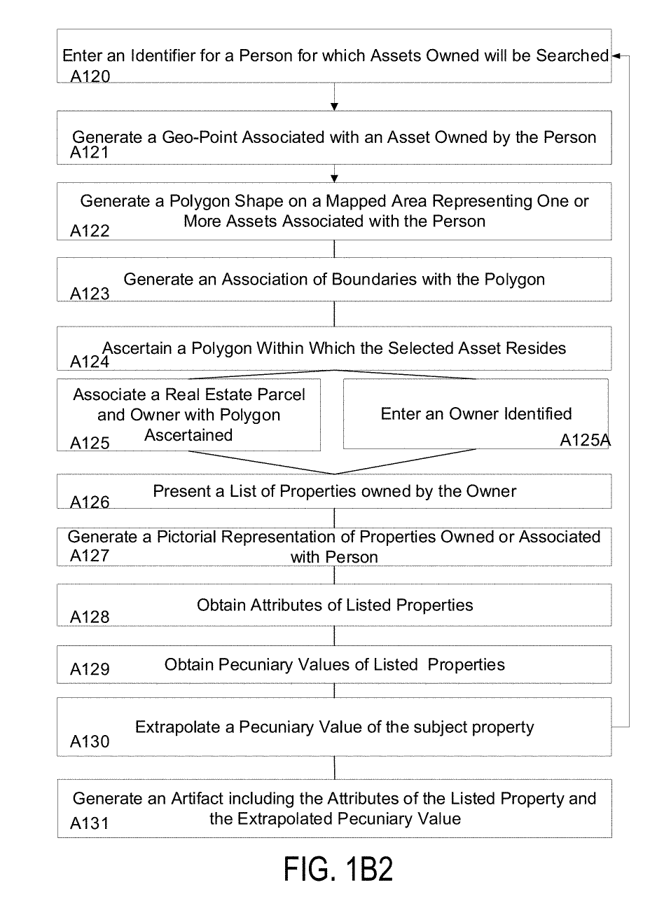

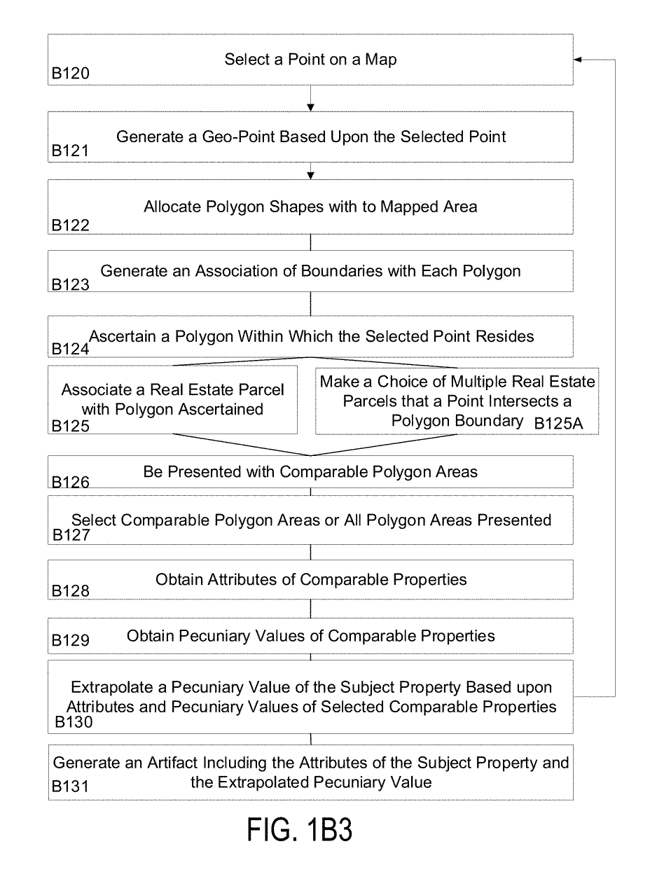

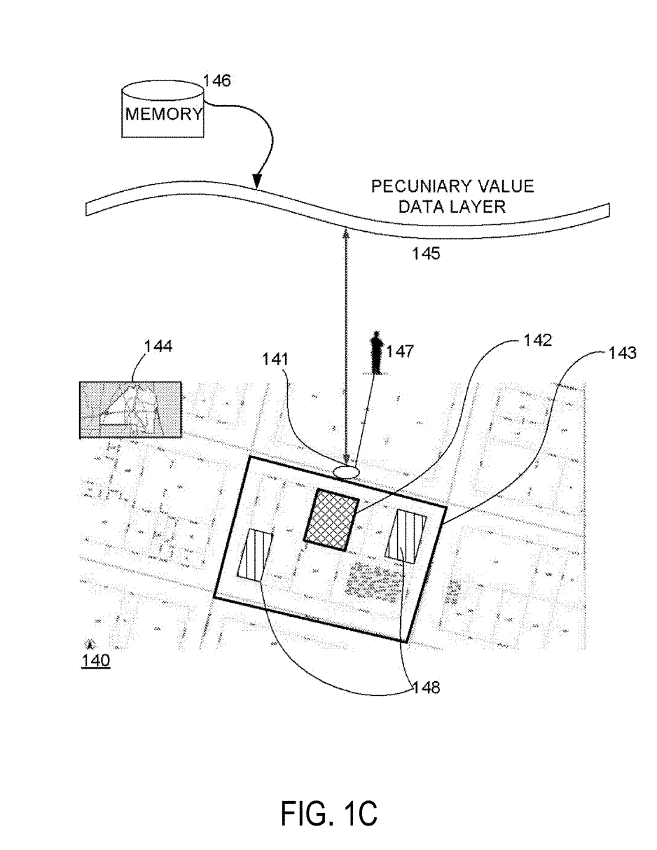

A functional diagram of some implementations of the present invention is illustrated in FIG. 1. According to the present invention a Geospatial Designation 101 is generated or otherwise specified by a user. As illustrated in this embodiment, the Geospatial Designation 101 is placed in the context of a real estate property parcel map 100 which may be found within a geographic area 104. The geospatial designation 101 can be associated with one or more geographic areas. The geospatial designation 101 may be associated, for example with one or more of: a real estate property parcel 102, a neighborhood or homeowners association 103 and another geographic or geopolitical boundary. Each geographic and/or geographic boundary may be associated with a person. A Person may be an individual, a corporate entity or other entity designated by law as a legal person.

Referring now to FIG. 1A, a functional diagram of some implementations of the present invention. According to the present invention a Geospatial Designation 101 is generated or otherwise specified by a user. As illustrated in this embodiment, a Geospatial Designation 101 from which image data or digital image data may be captured or from which a property location may be identified, is placed in the context of a real estate property parcel map 100. The geospatial designation 101 can be associated with one or more geographic areas 104 and one or more real estate assets 114. Each real estate asset 114 and/or geographic boundary 102 will be associated with a person for whom an asset search is being conducted. A Person may be an individual, a corporate entity or other entity designated by law as a legal person.

As discussed further below, association may be accomplished in an interactive database system wherein a Geospatial Designation 101 or a location of a real estate property 114 may be described in a mathematical sense, such as a spatial point defining system. Examples of a spatial point defining system may include a Cartesian Coordinate system or a Polar Coordinate system with a reference. In addition, a real property boundary may also be determined and indicated to a user upon request or in the normal interface provided to the user.

In some embodiments, a User 111 may operate a Geospatial Designation Identifier device at a point along a roadway or other right of way 113, and generate a Geospatial Designation 101. In some embodiments, Geospatial Designation Identifier 112 may include an image capture device, wherein a User may capture a picture or other image of a Geospatial Designation and simultaneously capture a Geospatial Designation 101 and a direction of image capture 105 and a Field of View.

In some implementations, a subject 114 may be determined based upon the captured Geospatial Designation 101 and direction of image capture 105 and Field of View. The subject may thereby be associated with a Geospatial Designation.

Referring now to FIG. 1B1 method steps that may be used to implement some embodiments of the present invention are presented. At method step 120 a point or area on an interactive map is selected. The point may be selected via a GUI, such as by a User clicking on a desired point on a GUI or dragging a user control over an area of a map, such as a stylus over an interactive map. Other implementations may include a user physically travelling to a destination and capturing a GPS location with a mobile gps device, such as a mobile phone with GPS capability. The User may wish to have the automated controller identify a person that is an owner of a property and also identify other properties owned by the person identified.

At step 121, in some embodiments a geo-point designation may be generated that correlates with an asset owned by the person identified. For example, a user may capture and input a GPS location and one or more of: an image of an asset and a direction in which an asset lies in relation to the user's GPS location. On a map type GUI, boundaries of a particular view of the asset may be associated with geographic limits and/or at least one known reference point from which other points may be calculated. An X, Y distance from a boundary or a reference point may be used to calculate a corresponding geographic location. In still further aspects a legal description may also be associated with one or more assets. A legal description may include one or more of: a street address, such as: 123 Main Street, City, and State; a meets and bounds description; a lot number and a historical designation.

At step 122, polygon shapes may be allocated to one or more mapped areas associated with assets owned by the person identified. At step 123, the polygons may be associated with boundaries. In some embodiments, the polygons will correspond with geopolitical boundaries, such as property parcels on a county map, subdivision boundaries, neighborhoods, townships, cities, etc. The boundaries may be useful to the user to better understand the nature of the asset for which a location is provided.

At method step 124, an automated controller (discussed in more detail below) ascertains which polygon the selected asset resides in. It may be ascertained via a simple database look up, via a geometric calculation, via a matrix associated with X, Y coordinates or other process capable of receiving a location and associating it with an area within a polygon shape or on a boundary defining a shape and/or boundary.

At method step 125, an automated controller may also associate a real estate parcel and/or a tax map identification with a person that is the owner of the asset represented by the polygon. At method step 125A a user may make a choice to enter a person identifier, such as a legal name or a taxpayer number. The user may enter the person identifier and store it for later reference by the automated controller and/or to implement a search of assets owned by the person. The search may be nationwide or constrained to a designated area.

At method step 126, a user may be presented with a list of potential status states associated with the property on which the search is being conducted. The status states may include a current value for one or more variables. In some preferred embodiments, a current status state may include, one or more of: whether a real estate property is currently listed for sale, sale pending, in contract, seeking funding, in foreclosure, has liens recorded against it, meets a loan to value criteria, ha a closing scheduled, is within proximity to another property with a designated state, zoning criteria or other aspect comprises a list of real estate properties identified via one or more of: a street address; a tax map number; a subdivision lot; Cartesian Coordinates such as latitude and longitude and common law description.

At method step 127 an automated controller may generate a pictorial representation of properties owned by the person on which the search is conducted. In some embodiments, an automated controller may select comparable assets and via the controller present the user with the comparable assets wherein the user who may then select some set of comparable properties via user interaction.

At method step 128 the automated controller receives a current status state for the one or more designated real estate properties. One preferred method of obtaining the attributes is to warehouse the attributes in a database of data previously normalized from multiple data sources and associated with the polygons and relevant real estate properties.

At method step 129 a user may input or otherwise convey a communication strategy. The communication strategy may be input via a user interface and/or via a drop down menu or package selection.

At method step 130, the automated controller will determine a communication type and the content of the communication. The communication type will be based, at least in part upon the communication strategy. The communication strategy can include, for example, a type of communication artifact, such as a hard copy mailing or a hard copy delivery, an electronic mailing, a text message, an audio message of other mode of communication. The communication strategy can also include content of one or more messages; a frequency of messages to be sent, an interval of time between communications, designated recipients for the communications or other variables associated with a program for communicating with a person associated with a real estate property.

At method step 131, the automated controller will generate a communication artifact based upon the Communication Strategy and a current real estate property status state, which may include, for example one or more of, attributes of the subject property, pictorial representations of the listed assets and extrapolated pecuniary value of the listed assets.

Referring now to FIG. 1B2 method steps that may be used to implement some embodiments of the present invention are presented. At method step A120 a point may be selected on a map. The point may be selected via a GUI, such as by a User clicking on a desired point on a GUI. Other implementations may include a user physically travelling to a destination and capturing a GPS location with a mobile device, such as a mobile phone with GPS capability. The User may wish to have the automated controller identify a person that is an owner of a property and also identify other properties owned by the person identified.

At step A121, in some embodiments a geo-point designation may be generated that correlates with an asset owned by the person identified. For example, a user may capture and input a GPS location and one or more of: an image of an asset and a direction in which an asset lies in relation to the user's GPS location. On a map type GUI, boundaries of a particular view of the asset may be associated with geographic limits and/or at least one known reference point from which other points may be calculated. An X, Y distance from a boundary or a reference point may be used to calculate a corresponding geographic location. In still further aspects a legal description may also be associated with one or more assets. A legal description may include one or more of: a street address, such as: A123 Main Street, City, and State; a meets and bounds description; a lot number and a historical designation.

At step A122, polygon shapes may be allocated to a one or more mapped areas associated with assets owned by the person identified.

At step A123, the polygons may be associated with boundaries. In some embodiments, the polygons will correspond with geopolitical boundaries, such as property parcels on a county map, subdivision boundaries, neighborhoods, townships, cities, etc. The boundaries may be useful to the user to better understand the nature of the asset for which a location is provided.

At method step A124, an automated controller (discussed in more detail below) ascertains which polygon the selected asset resides in. It may be ascertained via a simple database look up, via a geometric calculation, via a matrix associated with X, Y coordinates or other process capable of receiving a location and associating it with an area within a polygon shape or on a boundary defining a shape and/or boundary.

At method step A125, an automated controller may also associate a real estate parcel and/or a tax map identification with a person that is the owner of the asset represented by the polygon. At method step A125A a user may make a choice to enter a person identifier, such as a legal name or a taxpayer number. The user may enter the person identifier and store it for later reference by the automated controller and/or to implement a search of assets owned by the person. The search may be nationwide or constrained to a designated area.

At method step A126, a user may be presented with a list of assets associated with the person on which the search is being conducted. The asset list may include a written description of the asset and a location of the asset. In some preferred embodiments, the list of assets comprises a list of real estate properties identified via one or more of: a street address; a tax map number; a subdivision lot; Cartesian Coordinates such as latitude and longitude and common law description.

At method step A127 an automated controller may generate a pictorial representation of properties owned by the person on which the search is conducted. In some embodiments, an automated controller may select comparable assets and via the controller present the user with the comparable assets wherein the user who may then select some set of comparable properties via user interaction.

At method step A128 attributes descriptive of one or both of the person owned assets and comparable assets may be accessed by the automated controller and presented to the user. A common method of obtaining the attributes is to warehouse the attributes in a database of data previously normalized from multiple data sources and associated with the polygons and relevant real estate properties.

At method step A129 pecuniary values of one or both of the person owned assets and the comparable assets is obtained. Methods of obtaining the pecuniary values of comparable assets may include, for example, one or more of: recent sales data, calculations based upon attributes of the asset, square footage of improvements, size of a real estate area, location, or other factors.

At method step A130, the automated controller will extrapolate a pecuniary value of the subject asset, such as a real estate property, based upon the attribute of the person owned property and the attributes of the selected comparable assets and the pecuniary values of the selected assets or properties.

At method step A131, the automated controller will generate an artifact including one a list of assets owned by the person that is searched and one or more of: a location of assets owned by the person, attributes of the subject property, pictorial representations of the listed assets and extrapolated pecuniary value of the listed assets.

Referring now to FIG. 1B3 method steps that may be used to implement some embodiments of the present invention are presented. At method step B120 a point or area on an interactive map is selected. The point may be selected via a GUI, such as by a User clicking on a desired point on a GUI or dragging a user control over an area of a map, such as a stylus over an interactive map. Other implementations may include a user physically travelling to a destination and capturing a GPS location with a mobile device, such as a mobile phone with GPS capability. The User may wish to have the automated controller identify a person that is an owner of a property and also identify other properties owned by the person identified.

At step B121, in some embodiments a geo-point designation may be generated based on the point selected. In some examples, that point correlates with an asset owned by the person identified. For example, a user may capture and input a GPS location and one or more of: an image of an asset and a direction in which an asset lies in relation to the user's GPS location. On a map type GUI, boundaries of a particular view of the asset may be associated with geographic limits and/or at least one known reference point from which other points may be calculated. An X, Y distance from a boundary or a reference point may be used to calculate a corresponding geographic location. In still further aspects a legal description may also be associated with one or more assets. A legal description may include one or more of: a street address, such as: B123 Main Street, City, and State; a meets and bounds description; a lot number and a historical designation.

At step B122, polygon shapes may be allocated to a one or more mapped areas associated with the point selected. These may be correlated with assets owned by the person identified with the point.

At step B123, the polygons may be associated with boundaries. In some embodiments, the polygons will correspond with geopolitical boundaries, such as property parcels on a county map, subdivision boundaries, neighborhoods, townships, cities, etc. The boundaries may be useful to the user to better understand the nature of the asset for which a location is provided.

At method step B124, an automated controller (discussed in more detail below) ascertains which polygon the selected point/asset resides in. It may be ascertained via a simple database look up, via a geometric calculation, via a matrix associated with X,Y coordinates or other process capable of receiving a location and associating it with an area within a polygon shape or on a boundary defining a shape and/or boundary.

At method step B125, an automated controller may also associate a real estate parcel and/or a tax map identification with the point or with a person that is the owner of the asset represented by the polygon. At method step B125A a user may make a choice of multiple real estate parcels that a point intersects on a polygon boundary. The user may enter the desired point or a person identifier found to associate with the point and store it for later reference by the automated controller and/or to implement a search of assets owned by the person. The search may be nationwide or constrained to a designated area.

At method step B126, a user may be presented with a list of of comparable polygon areas within a view.

At method step B127 a user may select from the list of comparable polygon areas or may choose all members from the list via user interaction.

At method step B128 the automated controller receives attributes of the comparable properties.

At method step B129 the automated controller may obtain pecuniary values of the selected comparable properties/polygon areas.

At method step B130, the automated controller will extrapolate a pecuniary value of the subject property based upon attributes and pecuniary values of the selected comparable properties/polygon areas. Next the automated controller will determine a communication type and the content of the communication. The communication type will be based, at least in part upon the communication strategy. The communication strategy can include, for example, a type of communication artifact, such as a hard copy mailing, an electronic mailing, a text message, an audio message of other mode of communication. The communication strategy can also include content of one or more messages; a frequency of messages to be sent, an interval of time between communications, designated recipients for the communications or other variables associated with a program for communicating with a person associated with a real estate property.

At method step B131, the automated controller will generate a communication artifact based upon the Communication Strategy and an extrapolated pecuniary value, which may include, for example one or more of, attributes of the subject property, pictorial representations of the listed assets and extrapolated pecuniary value of the listed assets.

Referring now to FIG. 1C, a functional diagram illustrates some implementations of the present invention. According to the present invention a descriptive identifier of a person 147 is input by a User into an automated controller. The identifier may include a name, a tax identification number, a role or title of the person, and a primary location, such as a home address of the person for whom assets will be search.

The primary location may be, for example, indicated via a point on a graphical user interface (GUI) or a location determined by a mobile device equipped with global positioning system (OPS) capabilities. As illustrated in this embodiment, the Geospatial Designation 141 may be placed in the context of a map 140, such as a national geopolitical map, a road map, a county property parcel map or a subdivision plat map.

An automated controller may identify person owned properties via access to a database of real estate attributes, such as, for example, the Multiple Listing Service (MLS) database, the county tax database, or a private database, such as a subdivision database. A Person 147 may be an individual, a corporate entity, or other entity designated by law as a legal person.

According to the present invention, one or both of the Person 147 and the Geographic Area 142-144 is linked to a Data Layer 145 that includes one or both of property attributes and pecuniary values. In addition, one or more comparable properties 148 and/or a larger geographic area 143 that encompasses the Geographic Areas 142-144 and the Geospatial Designation 141 may be designated by the user or via an automated controller that calculates similar type properties via access to a database of real estate attributes, such as, for example, the Multiple Listing Service (MLS) database, the county tax database, or a private database, such as a subdivision database. Any or all Geographic Areas 142-144, 148 as defined by a Geographic Boundary of a geospatial designation 141 may be associated with a Person. A Person 147 may be an individual, a corporate entity, or other entity designated by law as a legal person. The Data Layer 145 may in turn be populated by logical communication with a Memory 146 storing related data.

The Data Layer 145 will include fields of alphanumeric data that may be used in execution of logical calculations. Logical calculations may include cross referencing disparate data layers to determine a data set of data fields. For example, a first data layer may include information indicating how many baths are included in multiple Geographic Areas and a second data layer may include a pecuniary value associated with a second and third bath. As discussed further below, association may be accomplished in an interactive database system wherein a Geospatial Designation 141 may be described in a mathematical sense, such as a spatial point defining system. Examples of a spatial point defining system may include a Cartesian Coordinate system or a Polar Coordinate system with a reference. A commonly known system may include Latitude and Longitude coordinates. The coordinates may be designated via a GUI or a location of a device with GPS capability.

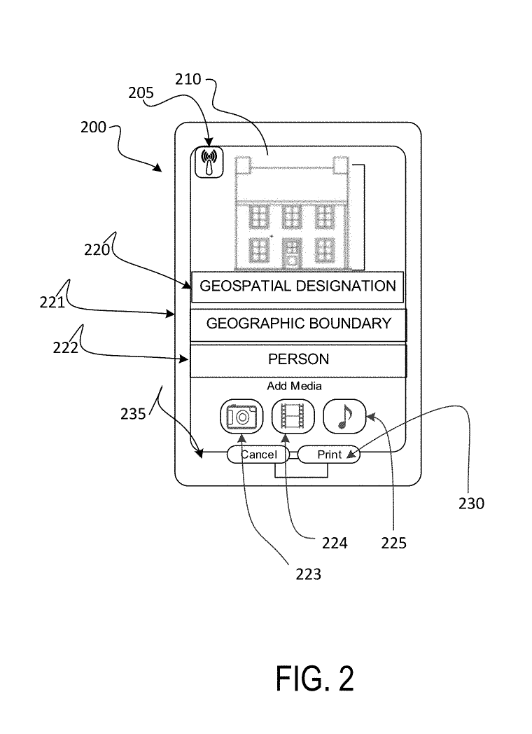

Referring now to FIG. 2, an exemplary Geospatial Designation Identifier 200 with functions of the Geospatial Designation Identifier 200 represented as a block type User Interface. It is understood by those schooled in the art that other User Interface designs, electromechanical control devices for functionality, and electronic control devices for functionality, are also within the scope of the present invention. For example, a function that includes generating a geospatial designation 220 may be accomplished via an electromechanical switch, an electronic switch or a programmed touchscreen.

Accordingly, in some embodiments, the Geospatial Designation Identifier 200 may include a device with User activated functionalities 220-225, 230 and 235. It should be noted that the Print functionality 230 may be functional to execute a communication conveyance, such as sending an electronic communication. The functionalities may include a capability to generate a Geospatial Designation 220, generate a Geographic Boundary 221 associated and generate a designation of a Person associated with the Geographic Boundary 221 generated. As discussed above, in some embodiments, a Geospatial Designation Identifier 200 may also include media capture functionality 223-225 with the capability to capture one or more of: an image 223, a video 224 and an audio segment 225.

In another aspect, the Geospatial Designation Identifier 200 may also include a Wireless capability, such as, for example functionality that operates in accordance with a communication protocol for digital communication. Examples of Wireless functionality may include, by way of non-limiting example, one or more of: Wireless Application Protocol (“WAP”) for mobile or fixed devices, 3G, 4G, 5G, Bluetooth, 802.11, or other types of wireless.

In still another aspect, a Geospatial Designation Identifier 200 device may include a display to allow a User to view captured image data, such as a still image or picture; or a video.

Geospatial Designation Identifier 200 may therefore include a mobile device or a relatively stationary device, such as a personal computer, a laptop or a server device configured with appropriate hardware and executable software to provide functionality to generate one or more of: a Geospatial Designation 220, associated communication parameters which may include the communication strategy and current status states and an associated Person 222. In addition, the Geospatial Designation Identifier 200 may include additional hardware and software to capture one or more of: a static image 223; multiple image frames in a video context 224; and an audio segment 225.

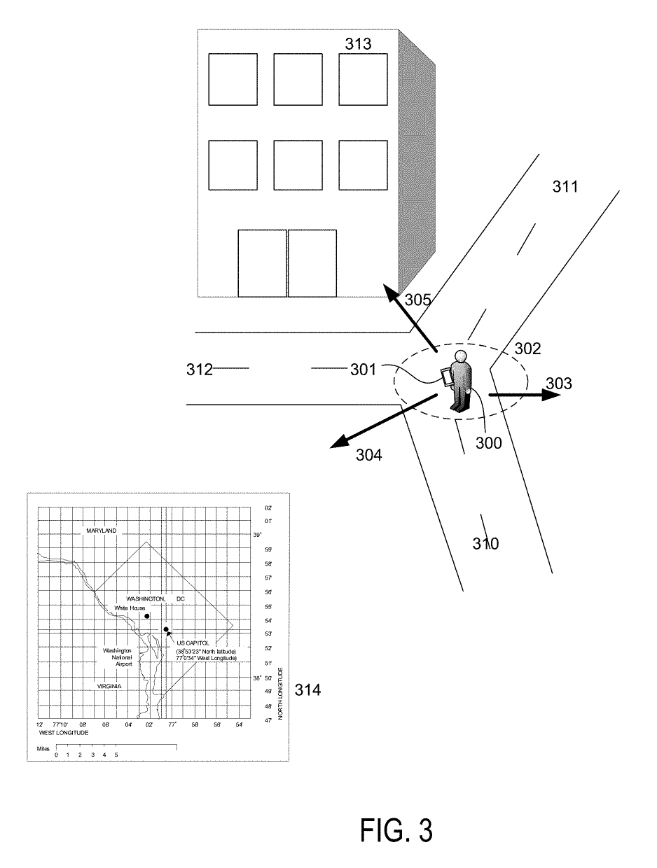

Referring now to FIG. 3, a close up view is illustrated of a User 300 with a handheld Geospatial Designation Identifier 301 and a Geospatial Designation 302 at an intersection with three roadways or other right of way 310-312. The handheld Geospatial Designation Identifier 301 may generate a Geospatial Designation 302 which in tum is associated with a person for whom assets will be searched. The handheld Geospatial Designation Identifier 301 may also generate a direction 303-305, or receive an input from a User indicating a direction 303-305. For example, in some embodiments a handheld Geospatial Designation Identifier 301 may include a directional indicator or directional device such as a compass. An interface with the User may allow a user to input a direction and the handheld Geospatial Designation Identifier 301 may correlate the input direction with mathematical representation of the input direction. The mathematical representation 314 may include for example, a value for directional degrees and minutes and be represented on the Geospatial Designation Identifier 301. In addition, in some embodiments, a subject 313 of an image capture may also be generated and associated with one or more of: the Geospatial Designation 302; the direction 303-305 a Geographic Area (not illustrated in FIG. 3); and a designated Person (not illustrated in FIG. 3).

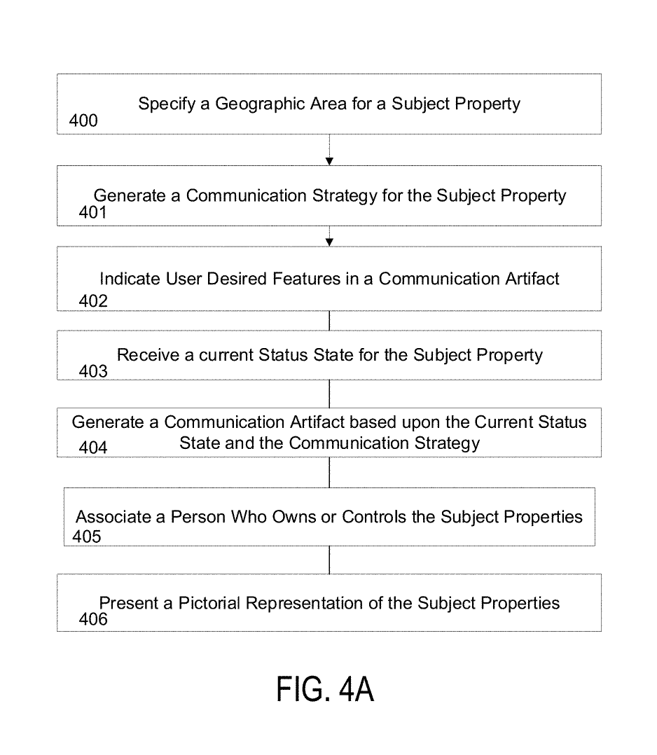

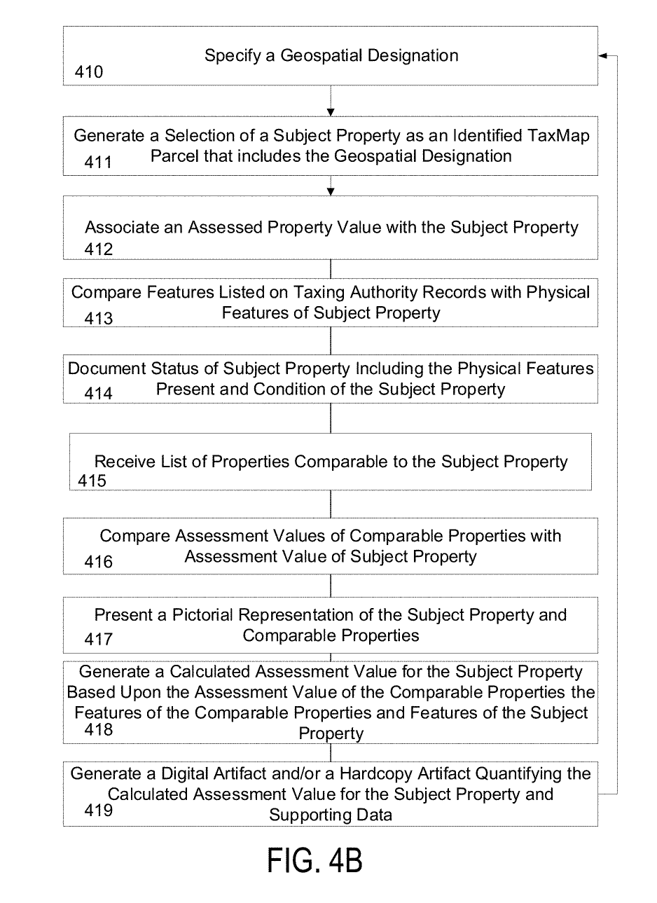

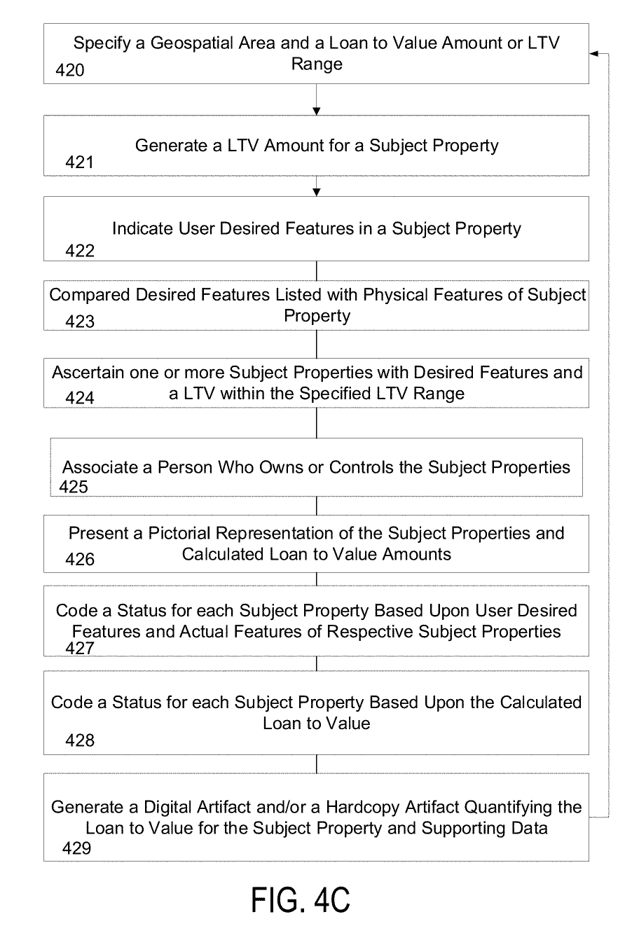

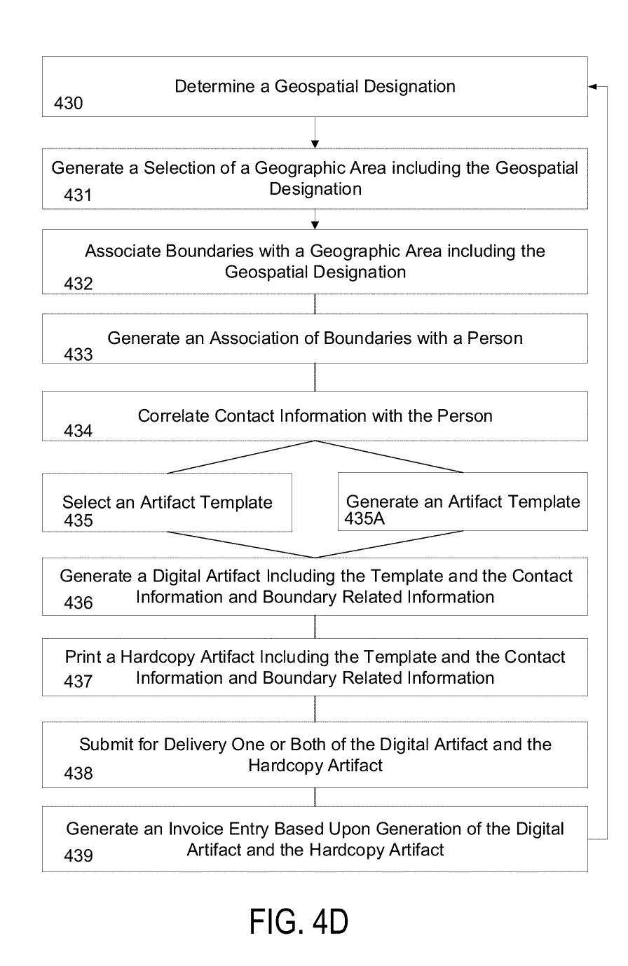

Referring now to FIG. 4A, method steps that may be performed in some implementations of the present invention are listed. The method steps provided herein may be performed by one or more of: a printer controller, a special purpose computer, a Geospatial Designation Indicator a mobile network access device, and stationary network access device. At 400, a Geospatial Designation may be determined. The Geospatial Designation may be determined via a Geospatial Designation Identifier device, or via a selection by a User of a point on an image, such as for example a graphical user interface with representations of one or more real estate parcels, street addresses, property lines, street intersections and the like.

At 400 a User may specify a geographic area to be associated with Communication Strategy. A Geographic Area is generated that includes the Geospatial Designation, as discussed herein, the Geographic Area, may be defined, by way of example, according to a User specified area type. The Geographic Area may be generated for example with a calculation that includes a User specified diameter, such as 0.5 miles or 5.0 miles around the Geospatial Designation. Other embodiments may include a User specified geopolitical area type associated with the Geospatial Designation, such as: real estate parcel, a real estate subdivision, within specified distance from the Geospatial Designation, a homeowners association, a township, a school district, a political district or other definable area. Comparable properties may be limited to the geographic area.

Geographic Boundaries are associated with the Geographic Area including the Geographic Designation. The Geographic Boundaries may be selected via User instruction such as an alphanumeric entry or via graphical user interface menu or a point a click of a graphical image. For example, a choice of a Geographic Boundary may be made via one or more of: a drop down menu, an outline on an interactive map, an alphanumeric description, and a tax map number, a lot number in a sub-division plat, homeowners association, a township, a county, a state, a school district, political district, or other a Geopolitical Area. In some embodiments, designation of various Geographic Boundaries may be made by linking disparate databases according to the Geographic Designation and an area included within a Geographic Boundary.

At 401 a communication strategy is determined for the subject property and may include a time period for the communication strategy to be executed, and variables to be included in the status state.

At 402 one or more User desired features may be specified to be included in a Communication Artifact.

At 403, the automated controller may receive a current status state for the subject property.

At 404 the automated controller will generate a communication artifact based the current status state and the communication strategy.

At 405 an association is generated of one or more of the selected Boundaries with a Person. The Person may be an individual, such as a property owner or a head of an organization, or it may be an organization, such as a corporate entity. The association of the Person with the Geographic Boundary may be generated based upon the Person's relationship with the Geographic Boundary selected by the User. In some embodiments, the association of the Person with the Boundary may be generated by linking disparate databases according to one or more of: the Geographic Designation and the Geographic Boundary.

Contact information for the Person associated with the Boundary may be correlated with the Person and the associated Boundary. Contact information may be correlated via the establishment of database links in a same or disparate databases. The Contact information provides an address to which an artifact destined for the Person may be mailed. The mail may by hardcopy mail, in which case the address will include a postal address or a street address. The mail may also be digital, in which case the address may be an electronic address, such as, one or more of: an email address, a social media address, a virtual private network address, a text message address or other electronic destination that may be associated with a person and receive an artifact.

Selection of an Artifact Template may also be made via a drop down list or other user interface. In some implementations, a User may provide input indicative of a purpose of the Artifact and the Printer Controller may present options to the User with options to the User based upon an indicated purpose. Other implementations may include an alphanumeric identifier of a template wherein the User may provide the identifier and the identified Template will be combined with the Boundary information and the Person information to generate an Artifact. The Artifact Template made be generated 405A, for example, via a word processor, or design or presentation software, or be derived from a captured image such as a scanned document or image.

At 406 a Digital Artifact is generated which includes the Communication Artifact and the Contact Information for the Boundary Information. The Communication Artifact includes a digital representation of a desired Hardcopy Artifact that will be generated.

One or both of the Hardcopy Artifact and the Digital Artifact are submitted for delivery to the Person associated with the Boundaries via the Contact Information linked to the Person. The step of submitting for delivery may include posting a Hardcopy Artifact via a parcel carrier service or an authorized postal mail service.

Referring now to FIG. 4B, method steps that may be performed in some implementations of the present invention are listed. The method steps provided herein may be performed by one or more of: an automated controller, a special purpose computer, a mobile network access device, and stationary network access device. At 410, a Geospatial Designation is specified by a User and received by the automated controller. The Geospatial Designation may be specified, for example via a User point and click on an image. Preferred embodiments include user interaction with a graphical user interface with representations of one or more real estate parcels, street addresses, property lines, street intersections and the like. Other embodiments may include a User accessing a mobile device on location proximate to the Subject Property, wherein a GPS or other location apparatus may designate coordinates that correspond with a location of the Subject Property.

At 411, the automated controller associates the geospatial designation for a subject property with a TaxMap parcel that includes the designated point. In various embodiments, a TaxMap parcel may also be designated via User instruction such as an alphanumeric entry or via graphical user interface menu or a point a click of a graphical image. For example a choice of a TaxMap parcel may be made via one or more of: a drop down menu, an outline on an interactive map, an alphanumeric description, a tax map number, a lot number in a sub-division plat, homeowners association, a township, a county, a state, a school district, political district, or other a Geopolitical Area.

At 412, the automated controller associates the assessed property value with the subject property. The assessed property value will typically be a value on record with a presiding tax authority.

At 413, the automated controller compares features listed on the taxing authority records with information that is input and is descriptive of current features of the subject property. For example, a list of rooms, types of rooms, square footage of a building, number of buildings or other improvements on a property, may all be included in a comparison of features included in tax authority records. Feature may therefore include, but not be limited to: size of number of structures included on a subject property; size of a property parcel; number of rooms including bedrooms and bathrooms: any improvements listed that are not present: defects in a building or property, such as an eroded grade, damaged driveway or right of way, damaged roof etc.; age of structures or other improvements; and Purchase date and price.

At 414, a current status of one or both of a subject property and a comparable property may be documented. Documentation may include, for example, date stamped images of a subject property, expert assessments of a condition of the property, such as a roofing inspection by a roofing expert, or a house inspection by a certified inspector; or other documentation.

At 415 a list of comparable properties, that have similar attributes and features and are proximate to the subject property is presented. The comparable properties may be presented via a user interactive map with images and features listed for each comparable property and a relative location of one or more of the comparable properties indicated on a map.

At 416 the automated controller may compare assessment values of comparable properties with the assessment value of the subject property. The comparison may be according to a simple delta or via a statistical placement of the subject property assessment as compared to the comparable properties. Non-limiting examples may include, an average assessment value for comparable properties and a median assessment value for comparable properties, a percentile rating, or other rating scheme.

At 417, a pictorial representation of the subject property a comparable properties is generated and presented in a human readable form, preferably in a GUI. The Pictorial may also include assessed value information and statistical information.

At 418, a calculated assessment value for the subject property is generated. The calculated assessment value may be based upon the assessment value of one or more comparable properties and features of the respective properties. A pecuniary value may be associated with one or more features associated with one or both of the comparable properties and the subject property. An aggregation of features and associated pecuniary values that add value or detract value may be included in a calculation of the assessment value of the subject property. In some embodiments, features are also afforded a weighted value.

At 419, one or both of a hardcopy artifact, or a softcopy artifact is generated that includes the calculate assessment value for the subject property and data supporting the calculated assessment. The data supporting the calculated assessment may include, by way of non-limiting example, one or more of: data descriptive of assessment values of comparable properties; a taxing algorithm used by a local tax authority, condition of one or more structures or other improvements on the subject property, number of rooms in a structure located on the subject property, type of rooms in a structure located on the subject property, size of the parcel and other features.

Referring now to FIG. 4C, method steps that may be performed in some implementations of the present invention are listed. The method steps provided herein may be performed by one or more of: an automated controller, a special purpose computer, a mobile network access device, and stationary network access device.

At 420, a user will specify a geographic area and a LTV amount or range of LTV amount. The geographic area may be specified via a cursor drag over or via a point and click Geospatial Designation which is received by the automated controller. The Geospatial Designation may be specified, for example via a User point and click on an image. Preferred embodiments include user interaction with a graphical user interface with representations of one or more real estate parcels, street addresses, property lines, street intersections and the like. Other embodiments may include a User accessing a mobile device on location proximate to the Subject Property, wherein a GPS or other location apparatus may designate coordinates that correspond with a location of the Subject Property.

A Loan to Value amount or range of amounts. For example a choice of a user may input a LTV value that indicates that properties with a LTV within the range are distressed properties on which a mortgage or other debt type is greater than the value of the property. Other debt types may include a debt which encumbers the property via a lien. Other ranges of LTV amounts may indicate that a property is entirely mortgage free or almost entirely mortgage free with very little debt involved. Such properties may be optimal for a transaction involving owner financing of some or all of the purchase price. A LTV analysis may compare recorded liens to a value calculated by the automated controller for each property in the designated area.

At 421 a LTV amount is generated for a subject property. A LTV for a property may be generated by comparing a known value of a comparable property and adjusting a calculated LTV based upon differences in features for the property with the known value and known features. A comparison used in determining a value of a specific property may be accomplished according to a simple delta or via a statistical analysis of a subject property features as compared to the comparable properties. Valuations may also be accomplished via statistical tools, such as, by way of non-limiting examples: an average known value for comparable properties and a median known value for comparable properties, a percentile rating, or other rating scheme.

At 422, a user will indicate desired features in a subject property. Desired features may include almost any aspect of a potential subject property. For example, a desired feature may include a property zoned for commercial or residential or CRO use, rang of square footage, number of bedrooms, a number of baths, and a range of an amount of acreage or other descriptor of a feature.

At 423, the automated controller compares features listed on layers of associated data with records of information that is input and/or electronically accessed and is descriptive of current features of one or more subject properties. For example, a list of rooms, types of rooms, square footage of a building, number of buildings or other improvements on a property, may all be included in a comparison of features included in tax authority records. Feature may therefore include, but not be limited to: size of number of structures included on a subject property; size of a property parcel; number of rooms including bedrooms and bathrooms; any improvements listed that are not present; defects in a building or property, such as an eroded grade, damaged driveway or right of way, damaged roof etc.; age of structures or other improvements; and Purchase date and price. Layers of data may be linked from county data, multiple listing data, owner supplied data, user supplied data, or other source of data.

In some embodiments, a current status of one or both of a subject property and a comparable property may be documented in a data layer Documentation may include, for example, date stamped images of a subject property, expert assessments of a condition of the property, such as a roofing inspection by a roofing expert, or a house inspection by a certified inspector; or other documentation.

At 424, the automated controller will ascertain one or more subject properties with desired features as provided a user and a LTVA amount within a specified LTVA range. The subject properties may be presented via a user interactive map with images and features listed for each comparable property and a relative location of one or more of the comparable properties indicated on a map.

At 425 the automated controller will associate a person who owns or controls a subject property with a property identified as meeting specified criteria for features and LTV amount.

At 426 the automated controller presents a pictorial representation of a location of one or more subject properties. The pictorial representation of the subject property and/or comparable properties is generated and presented in a human readable form, preferably in a GUI. The Pictorial may also include LTV related information and statistical information.

At 427, a property may be coded or otherwise associated with a classification of a state of the property, such as a “distressed” property; an “upside down.” property” and a candidate for owner financing.

At 428, a code or status may be associated with a subject property based upon a calculated loan to value.

At 429, one or both of a hardcopy artifact, or a softcopy artifact is generated that includes the calculated LTV assessment value for the subject property and data supporting the calculated LTV. The data supporting the calculated LTV may include, by way of non-limiting example, one or more of: data descriptive of sales prices of comparable properties; a condition of one or more structures or other improvements on the subject property, number of rooms in a structure located on the subject property, type of rooms in a structure located on the subject property, size of the parcel and other features.

Referring now to FIG. 4D, method steps that may be performed in some implementations of the present invention are listed. The method steps provided herein may be performed by one or more of: a printer controller, a special purpose computer, a Geospatial Designation Indicator a mobile network access device, and stationary network access device. At 430, a Geospatial Designation may be determined. The Geospatial Designation may be determined via a Geospatial Designation Identifier device, or via a selection by a User of a point on an image, such as for example a graphical user interface with representations of one or more real estate parcels, street addresses, property lines, street intersections and the like.

At 431, a Geographic Area is generated that includes the Geospatial Designation, as discussed herein, the Geographic Area, may be defined, by way of example, according to a User specified area type. The Geographic Area may be generated for example with a calculation that includes a User specified diameter, such as 0.5 miles or 5.0 miles around the Geospatial Designation. Other embodiments may include a User specified geopolitical area type associated with the Geospatial Designation, such as: real estate parcel, a real estate subdivision, within specified distance from the Geospatial Designation, a homeowners association, a township, a school district, a political district or other definable area.

At 432 one or more sets of Geographic Boundaries are associated with the Geographic Area including the Geographic Designation. The Geographic Boundaries may be selected via User instruction such as an alphanumeric entry or via graphical user interface menu or a point a click of a graphical image. For example a choice of a Geographic Boundary may be made via one or more of: a drop down menu, an outline on an interactive map, an alphanumeric description, and a tax map number, a lot number in a sub-division plat, homeowners association, a township, a county, a state, a school district, political district, or other a Geopolitical Area. In some embodiments, designation of various Geographic Boundaries may be made by linking disparate databases according to the Geographic Designation and an area included within a Geographic Boundary.

At 433, an association is generated of one or more of the selected Boundaries with a Person. The Person may be an individual, such as a property owner or a head of an organization, or it may be an organization, such as a corporate entity. The association of the Person with the Geographic Boundary may be generated based upon the Person's relationship with the Geographic Boundary selected by the User. In some embodiments, the association of the Person with the Boundary may be generated by linking disparate databases according to one or more of: the Geographic Designation and the Geographic Boundary.

At 434, contact information for the Person associated with the Boundary may be correlated with the Person and the associated Boundary. Contact information may be correlated via the establishment of database links in a same or disparate databases. The Contact information provides an address to which an artifact destined for the Person may be mailed. The mail may by hardcopy mail, in which case the address will include a postal address or a street address. The mail may also be digital, in which case the address may be an electronic address, such as, one or more of: an email address, a social media address, a virtual private network address, a text message address or other electronic destination that may be associated with a person and receive an artifact.

At 435 and 435A an Artifact Template may be selected by a User or generated by a User. The Artifact Template will typically be a document, such as, one or more of: a letter, a contract, a sales offer, an offer to purchase and an advertisement marketing a product or service. However, in other implementation, the present invention may generate other tangible artifacts, such as signage or an image replication.

Selection of an Artifact Template 435 may be made via a drop down list or other user interface. In some implementations, a User may provide input indicative of a purpose of the Artifact and the Printer Controller may present options to the User with options to the User based upon an indicated purpose. Other implementations may include an alphanumeric identifier of a template wherein the User may provide the identifier and the identified Template will be combined with the Boundary information and the Person information to generate an Artifact.

The Artifact Template made be generated 435A, for example, via a word processor, or design or presentation software, or be derived from a captured image such as a scanned document or image.

At 436 a Digital Artifact is generated which includes the Artifact Template and the Contact Information for the Boundary Information. The Digital artifact includes a digital representation of a desired Hardcopy Artifact that will be generated.

At 437, the printer controller provides instructions which cause a hardcopy artifact to be printed, or otherwise created, based upon the Artifact Template, the Contact Information and the Boundary Related Information.

At 438, one or both of the Hardcopy Artifact and the Digital Artifact are submitted for delivery to the Person associated with the Boundaries via the Contact Information linked to the Person. The step of submitting for delivery may include posting a Hardcopy Artifact via a parcel carrier service or an authorized postal mail service.

At 439, the print server may automatically generate an invoice entry based upon the generation of one or both of: the Digital Artifact and the Hardcopy Artifact. The invoice entry may include an invoiced amount based upon one or more of: the complexity of the generation of the Digital Artifact and the Hardcopy Artifact; inclusion of an image of a Geographic Area, a size of the Digital Artifact and/or the Hardcopy Artifact; an amount charged for delivery; a number of recipients or other cost of goods variable.

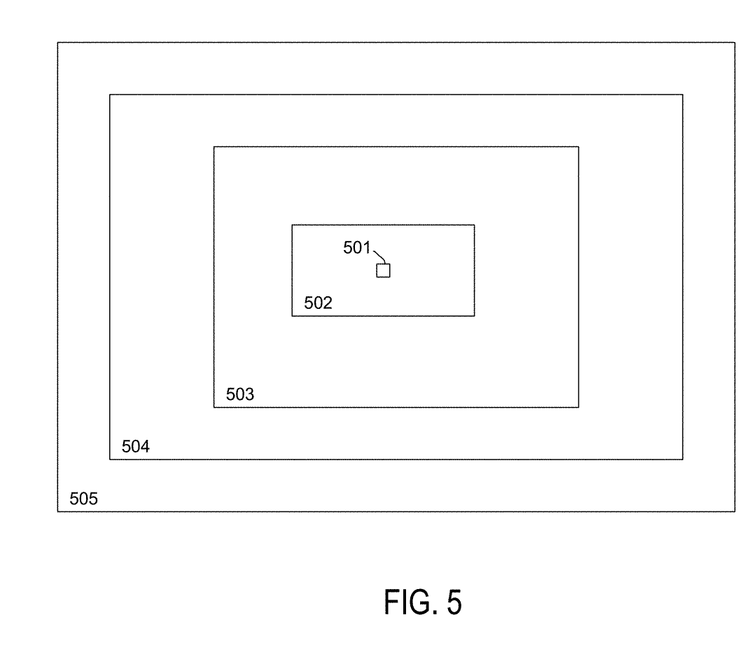

Referring now to FIG. 5, a block diagram of a Geospatial Designation 501 and multiple Geographic Areas are illustrated. The location of the Geospatial Designation 501 may be described in a mathematical sense, such as a spatial point with a base reference. In some embodiments, the location of the Geospatial Designation 501 a may also be expressed in relation to one or more of the Geographic Areas. Examples of a mathematical representation of the Geospatial Designation 501 may include a Cartesian Coordinate, such as a defined latitude and longitude. Another example may include a Polar Coordinate system with a vector value in combination with a start point and an angle. A defined Cartesian Coordinate and/or the Polar Coordinate may then be associated with one or more defined areas that include point defined by the Cartesian Coordinate.

As illustrated Geographic Areas 502-505 may include increasingly expanding areas with a smallest area 502 being a subset of one or more larger areas 503-505. Intermediate areas 503-504 may include some smaller areas 502 and be included within a larger area 505. In other embodiments, a Geographic Area 502-505 may only overlap at the point of the Geospatial Designation 501.

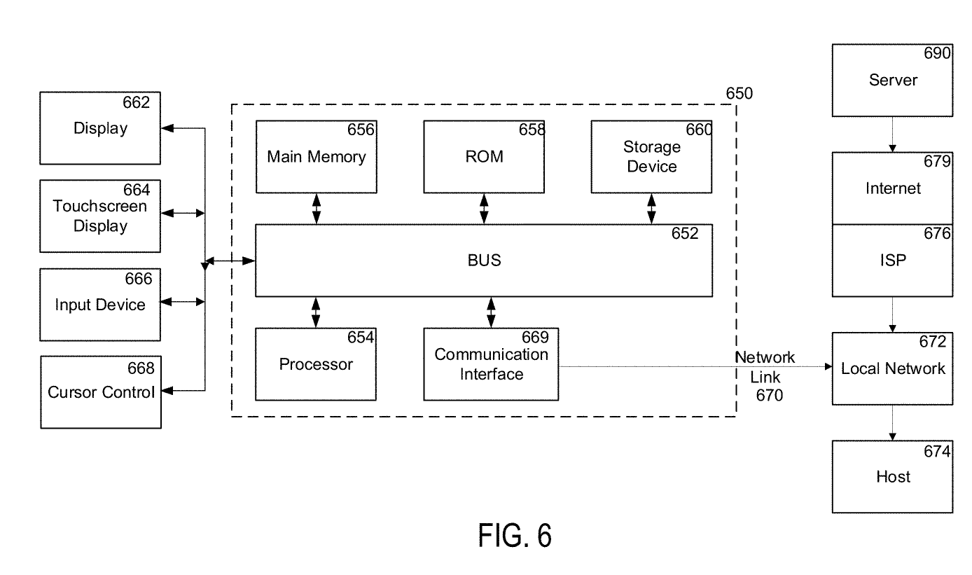

Referring now to FIG. 6, additional aspects of printer controller hardware useful for implementing the present invention are illustrated as a block diagram that includes a controller 650 upon which an embodiment of the invention may be implemented. Controller 650 includes a digital bus 652 or other communication mechanism for communicating information, and a processor 654 coupled with digital bus 652 for processing information.

Controller 650 also includes a main memory 656, such as a random-access memory (RAM) or other dynamic storage device, coupled to digital bus 652 for storing information and instructions to be executed by processor 654. Main memory 656 may also be used for storing temporary variables or other intermediate information during execution of instructions to be executed by processor 654. Controller 650 further includes a read only memory (ROM) 658 or other static storage device 660.

Controller 650 may be coupled via digital bus 652 to a display 662, such as a cathode ray tube (CRT), liquid crystal display (LCD), plasma display panel (PDP), organic light-emitting diode (OLED), projector, or heads up display for displaying information to a computer user. An input device 666, including alphanumeric and other keys, may be coupled to digital bus 652 for communicating information and command selections to processor 654. Another type of user input device is cursor control 668, such as a mouse, a trackball, a touchpad, or cursor direction keys for communicating direction information and command selections to processor 654 and for controlling cursor movement on display 662. Another type of user input device is a touchscreen display 664 where a user may communicate information and command selections to processor 654 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane.

Embodiments of the invention are related to the use of controller 650 for setting operational parameters relating to digital messaging and game playing. According to some embodiment of the invention, layering system parameters are defined and managed by controller 650 in response to processor 654 executing one or more sequences of one or more instructions contained in main memory 656. Such instructions may be read into main memory 656 from another computer-readable medium, such as storage device 660. Execution of the sequences of instructions contained in main memory 656 causes processor 654 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 654 for execution. Such a medium may take many forms, including but not limited to, non-volatile media, volatile media, and transmission media. Non-volatile media includes, for example, optical or magnetic disks, such as a storage device 660 and a read only memory (ROM) 658. Volatile media includes dynamic memory, such as main memory 656. Transmission media includes coaxial cables, copper wire and fiber optics, including the wires that comprise digital bus 652. Transmission media may also take the form of acoustic or light waves, such as those generated during radio wave and infrared data communications.

Common forms of computer-readable media include, for example, a memory stick, hard disk or any other magnetic medium, a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 654 for execution. For example, the instructions may initially be carried on a magnetic disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on digital bus 652. Digital bus 652 carries the data to main memory 656, from which processor 654 retrieves and executes the instructions. The instructions received by main memory 656 may optionally be stored on storage device 660 either before or after execution by processor 654.

Controller 650 also includes a communication interface 669 coupled to digital bus 652. Communication interface 669 provides a two-way data communication coupling to a network link 670 that may be connected to a local network 672. For example, communication interface 669 may operate according to the internet protocol. As another example, communication interface 669 may be a local area network (LAN) card allowing a data communication connection to a compatible LAN. Wireless links may also be implemented.

Network link 670 typically provides data communication through one or more networks to other data devices. For example, network link 670 provides a connection through local network 672 to a host computer 674 or to data equipment operated by an Internet Service Provider (ISP) 676. ISP 676 in turn provides data communication services through the worldwide packet data communication network now commonly referred to as the “Internet” 679. Local network 672 and Internet 679 both use electrical, electromagnetic or optical signals that carry digital data streams. The signals through the various networks and the signals on the network link 670 and through communication interface 669, which carry the digital data to and from controller 650 are exemplary forms of carrier waves transporting the information.

In some embodiments, Controller 650 may send messages and receive data, including program code, through the network(s), network link 670 and communication interface 669. In the Internet example, a server 690 might transmit a requested code for an application program through Internet 679, ISP 676, local network 672 and communication interface 669.

Processor 654 may execute the received code as it is received, and/or stored in storage device 660, or other non-volatile storage for later execution. In this manner, controller 650 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk or other type of automated apparatus. Additional exemplary devices may include any device with a processor executing programmable commands to accomplish the steps described herein.

A controller may be a programmable board such as an arduino board, and/or one or more of: personal computers, laptops, pad devices, mobile phone devices and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random-access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices; magnetic disks such as, internal hard disks and removable disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of memory, information updating, order execution, redemption and issuance. Any number of commercially available database engines may allow for substantial account coverage and expansion. The controlling logic may use a language and compiler consistent with that on a CPU included in the medical device. These selections will be set according to per se well-known conventions in the software community.

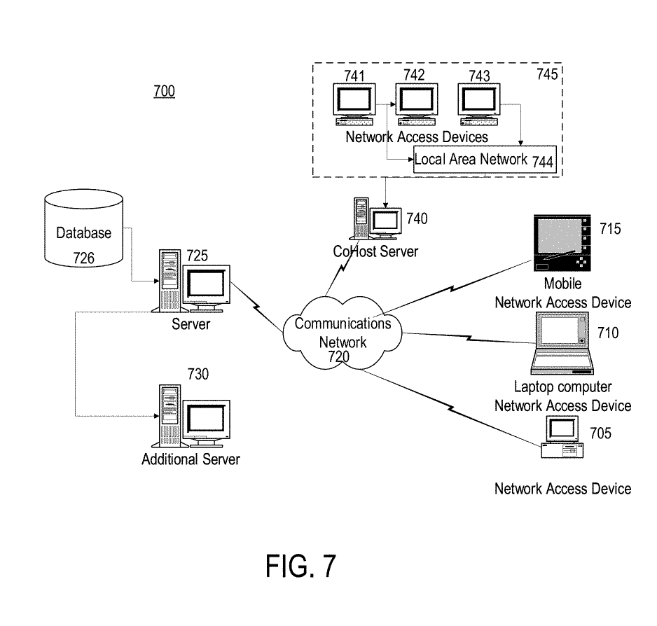

Referring now to FIG. 7, an exemplary processing and interface system 700 is illustrated. In some aspects, access devices 715, 710, 705, such as a mobile device 715 or laptop computer 710 may be able to communicate with an external server 725 though a communications network 720. The external server 725 may be in logical communication with a database 726, which may comprise data related to identification information and associated profile information. In some examples, the server 725 may be in logical communication with an additional server 730, which may comprise supplemental processing capabilities.

In some aspects, the server 725 and access devices 705, 710, 715 may be able to communicate with a cohost server 740 through a communications network 720. The cohost server 740 may be in logical communication with an internal network 745 comprising network access devices 741, 742, 743 and a local area network 744. For example, the cohost server 740 may comprise a payment service, such as PayPal or a social network, such as Facebook or a dating website.

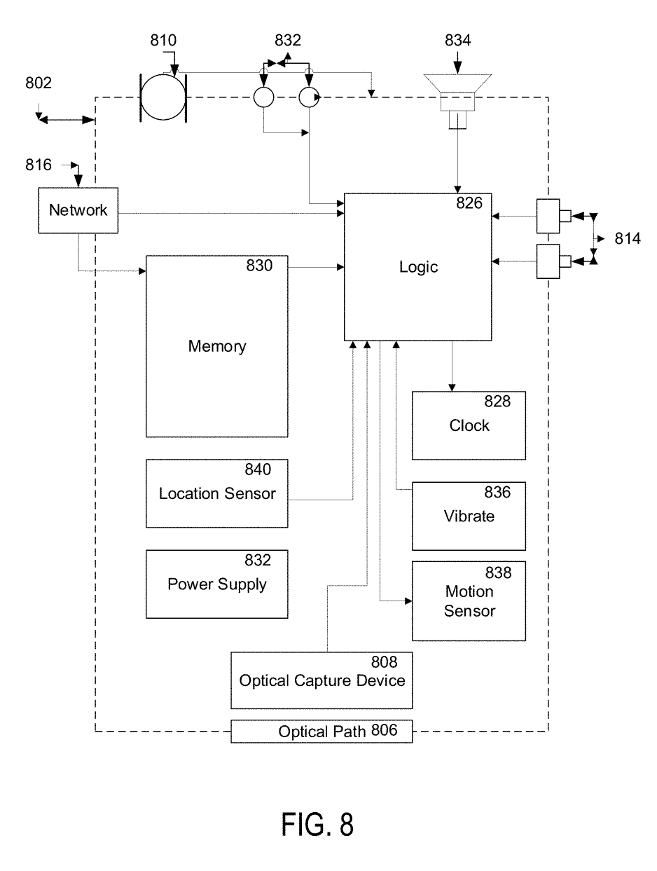

Referring now to FIG. 8, a block diagram of an exemplary embodiment of a mobile device 802 is illustrated. The mobile device 802 may comprise an optical capture device 808, which may capture an image and convert it to machine-compatible data, and an optical path 806, typically a lens, an aperture, or an image conduit to convey the image from the rendered document to the optical capture device 808. The optical capture device 808 may incorporate a Charge-Coupled Device (CCD), a Complementary Metal Oxide Semiconductor (CMOS) imaging device, or an optical sensor of another type.

In some embodiments, the mobile device 802 may comprise a microphone 810, wherein the microphone 810 and associated circuitry may convert the sound of the environment, including spoken words, into machine-compatible signals. Input facilities 814 may exist in the form of buttons, scroll-wheels, or other tactile sensors such as touch-pads. In some embodiments, input facilities 814 may include a touchscreen display. Visual feedback to the user may occur through a visual display, touchscreen display, or indicator lights. Audible feedback 834 may be transmitted through a loudspeaker or other audio transducer. Tactile feedback may be provided through a vibration module 836.

In some aspects, the mobile device 802 may comprise a motion sensor 838, wherein the motion sensor 838 and associated circuity may convert the motion of the mobile device 802 into machine-compatible signals. For example, the motion sensor 838 may comprise an accelerometer, which may be used to sense measurable physical acceleration, orientation, vibration, and other movements. In some embodiments, the motion sensor 838 may comprise a gyroscope or other device to sense different motions.

In some implementations, the mobile device 802 may comprise a location sensor 840, wherein the location sensor 840 and associated circuitry may be used to determine the location of the device. The location sensor 840 may detect Global Position System (GPS) radio signals from satellites or may also use assisted GPS where the mobile device may use a cellular network to decrease the time necessary to determine location. In some embodiments, the location sensor 840 may use radio waves to determine the distance from known radio sources such as cellular towers to determine the location of the mobile device 802. In some embodiments, these radio signals may be used in addition to and/or in conjunction with GPS.

In some aspects, the mobile device 802 may comprise a logic module 826, which may place the components of the mobile device 802 into electrical and logical communication. The electrical and logical communication may allow the components to interact. Accordingly, in some embodiments, the received signals from the components may be processed into different formats and/or interpretations to allow for the logical communication. The logic module 826 may be operable to read and write data and program instructions stored in associated storage 830, such as RAM, ROM, flash, or other suitable memory. In some aspects, the logic module 826 may read a time signal from the clock unit 828. In some embodiments, the mobile device 802 may comprise an on-board power supply 832. In some embodiments, the mobile device 802 may be powered from a tethered connection to another device, such as a Universal Serial Bus (USB) connection.

In some implementations, the mobile device 802 may comprise a network interface 816, which may allow the mobile device 802 to communicate and/or receive data to a network and/or an associated computing device. The network interface 816 may provide two-way data communication. For example, the network interface 816 may operate according to an internet protocol. As another example, the network interface 816 may comprise a local area network (LAN) card, which may allow a data communication connection to a compatible LAN. As another example, the network interface 816 may comprise a cellular antenna and associated circuitry, which may allow the mobile device to communicate over standard wireless data communication networks. In some implementations, the network interface 816 may comprise a Universal Serial Bus (USB) to supply power or transmit data. In some embodiments, other wireless links known to those skilled in the art may also be implemented.

As an illustrative example of a mobile device 802, a reader may scan some text from a newspaper article with mobile device 802. The text is scanned as a bit-mapped image via the optical capture device 808. Logic 826 causes the bit-mapped image to be stored in memory 830 with an associated time-stamp read from the clock unit 828. Logic 826 may also perform optical character recognition (OCR) or other post-scan processing on the bit-mapped image to convert it to text. Logic 826 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 826) to an associated computer via network interface 816.

As an example of another use of mobile device 802, a reader may capture some text from an article as an audio file by using microphone 810 as an acoustic capture port. Logic 826 causes audio file to be stored in memory 830. Logic 826 may also perform voice recognition or other post-scan processing on the audio file to convert it to text. As above, the reader may then upload the audio file (or text produced by post-scan processing performed by logic 826) to an associated computer via network interface 816.

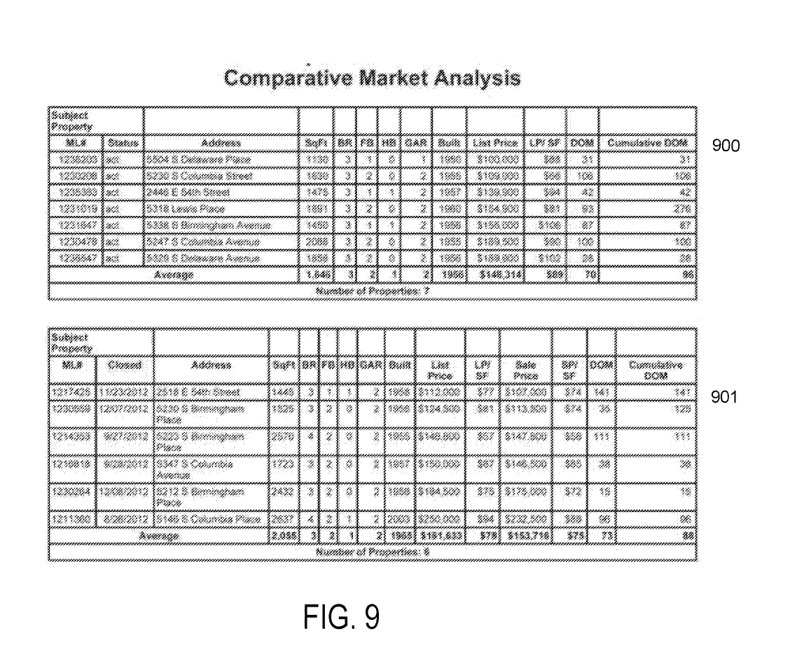

Referring now to FIG. 9, exemplary grids 900-901 of subject and comparable property attributes and pecuniary values is shown that may be generated via the apparatus and process discussed herein. In some embodiments, the automated controller may provide a Comparative Market Analysis to support a valuation of a subject property based upon valuations of similar or comparable properties in a vicinity that includes the subject property. Exemplary CMAs may include grids of subject and comparable property attributes and pecuniary values is shown that may be generated via the apparatus and process discussed herein.

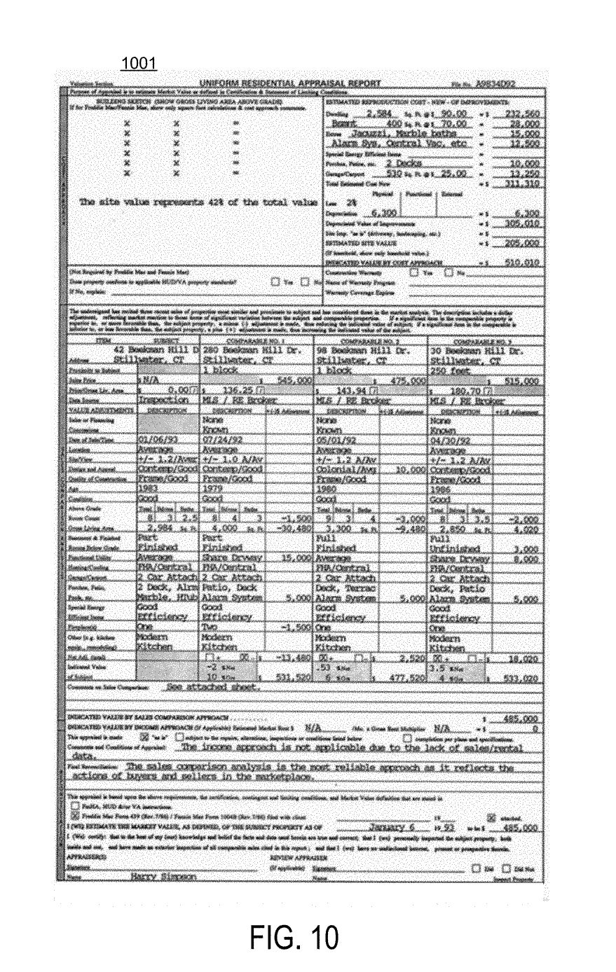

Referring now to FIG. 10, in some specific embodiment's, attributes and pecuniary vales of a subject property and cone or more comparable properties may be used to populate a Uniform Real Estate Appraisal form 1001 of similar scope and with a look and feel of those forms propagated by Freddie Mac.

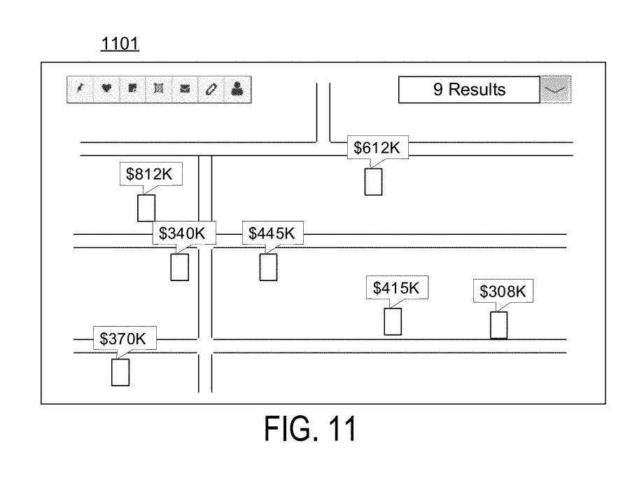

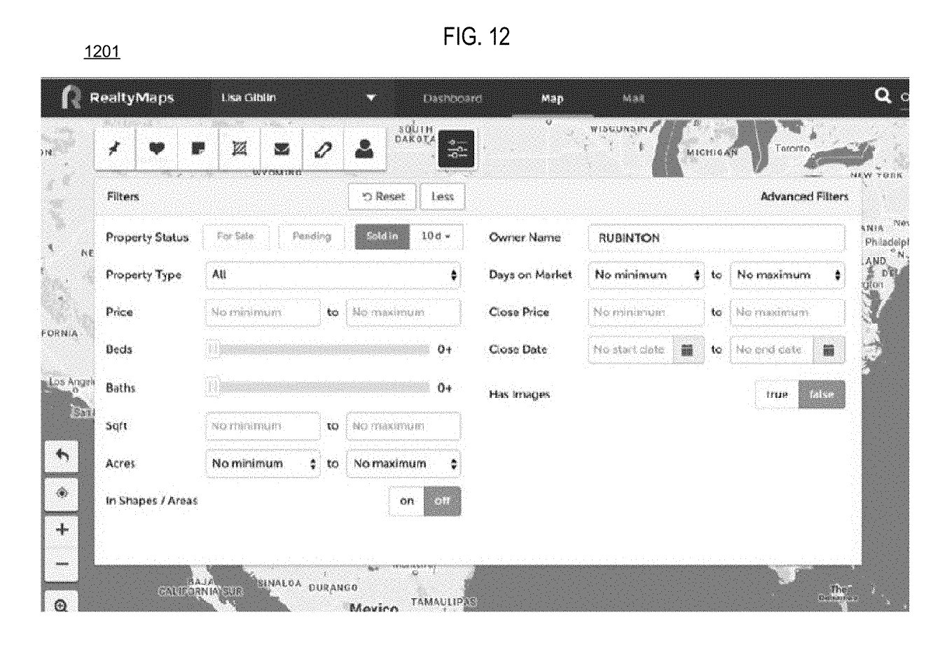

Referring now to FIG. 11-12 include exemplary graphical user interface content 1101 and data content 1201 that may be utilized in some embodiments of the present invention.

### Multi-jurisdiction Asset Locator and Analysis

Some aspects of the present invention relate to an asset location controller and methods of operating the asset location controller to generate a listing of assets and associate the assets with a geospatial designation. A user may input an identifier for a Person, such as a legal name or tax payer number and an automated controller returns to the user one or both of a list of assets owned by the person and a pictorial view of locations of assets owned by the person. These concepts are further described in the U.S. provisional patent application Ser. No. 62/394,380, filed Sep. 14, 2016, and entitled: “Automated Location Based Comparative Market Analysis” the contents of which are incorporated herein in their entirety by reference.

### Automated Assessed Property Value Challenge

Some aspects of the present invention relate to an automated controller and methods of operating the automated controller to generate a Property Assessment Value based upon current market conditions and values of properties in proximity to a geospatial designation provided by a user. The geospatial designation is associated with subject property parcel and physical (tangible) attributes contained within the subject property parcel. In some embodiments, the geospatial designation is also associated with intangible attributes. Intangible attributes may include one or more of: a view, deeded rights to access nearby amenities; conditions in a geographic area proximate to the parcel; a condition of structures on the parcel, local zoning, events affecting a local economy, market demand for properties of a size and type similar to the subject property, or other factor which may affect a real estate property value. Tangible and intangible attributes are referenced to generate a current subject property value from which a current property assessment value is derived. These concepts are further described in the U.S. provisional patent application Ser. No. 62/397,839, filed Sep. 21, 2016 and entitled: “Automated Assessed Property Value Challenge” the contents of which are incorporated herein in their entirety by reference.

### Automated Real Property Loan to Value Controller

Some aspects of the present invention relate to an automated controller and methods of operating the automated controller to generate an assessment of a real property transaction potential based upon a loan to value amount associated with a particular property in combination with one or more of: current market conditions; values of properties in proximity to a geospatial location of the property. The geospatial designation is associated with subject property parcel and physical (tangible) attributes contained within the subject property parcel. In some embodiments, the geospatial designation is also associated with intangible attributes. Intangible attributes may include one or more of: a view, deeded rights to access nearby amenities; conditions in a geographic area proximate to the parcel; a condition of structures on the parcel, local zoning, events affecting a local economy, market demand for properties of a size and type similar to the subject property, or other factor which may affect a real estate property value. Tangible and intangible attributes are referenced to generate a current subject property value from which a current property assessment value is derived. A loan to value assessment is generated based upon such factors and/or features and amount owed on the property. These concepts are further described in the U.S. provisional patent application Ser. No. 62/397,974, filed Sep. 22, 2016 and entitled: “Automated Real Property Loan To Value Controller ” the contents of which are incorporated herein in their entirety by reference.

### A Real Property Benchmark Event Automated Communication Generator

Some aspects of the present invention relate to an automated real property status change controller and methods of operating the real property status change controller to execute a communication strategy that may include physical artifacts. The real property status change may be associated with a determined geospatial location and one or more sets of boundaries associated with the geospatial location. Each set of boundaries is in turn associated with a point of contact person. Upon command, the automated real property status change controller will generate a communication artifact specific to the geospatial location and a person predicated upon a choice of boundaries made by a user and a desired communication based upon a current state of the property. A communication strategy may include multiple artifacts communicated multiple discrete time intervals. These concepts are further described in the U.S. provisional patent application Ser. No. 62/416,076, filed Nov. 1, 2016 and entitled: “Automated Real Property Benchmark Event Automated Communication Generator” the contents of which are incorporated herein in their entirety by reference.

A number of embodiments of the present disclosure have been described. While this specification contains many specific implementation details, there should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

In certain implementations, multitasking and parallel processing may be advantageous. Nevertheless, it will be understood that various modifications may be made without departing from the spirit and scope of the claimed disclosure.

What is claimed is:

1. A printer controller for generating hardcopy artifacts, the printer controller comprising:
a processor;
a main memory in logical communication via a digital bus with the processor, said main memory storing executable software, the executable software operative with the processor to cause the printer controller to:
receive from a user interaction a selected point associated with a Geospatial Designation;
generate a selection of a polygon associated with a Geographic Area;
generate a Boundary for the polygon associated with the Geographic Area;
generate an association of the Boundary for the Geographic Area with a Person;
determine that the selected point is included within one of the polygon and the boundary;
designate a Person with contact information including at least an address for receiving a hard copy delivery;
access a storage of attributes related to the Geographic Area designated;
automatically associate with a controller at least one comparable real estate property;
access attributes descriptive of the at least one comparable real estate property;
access a pecuniary value associated with the at least one comparable real estate property;
generate a comparative market analysis report comprising: a template for listing the attributes of the at least one comparable real estate property and respective pecuniary values for each comparable real estate property and a calculated value of the geographic area associated with the selected point; and
generate a hardcopy artifact including the comparative market analysis report and reference to the Person.

2. The printer controller of claim 1, wherein the printer controller receives an alphanumeric identifier of the template to be referenced in the generating of the hardcopy artifact.

3. The printer controller of claim 1, wherein the printer controller is further caused to generate the template based upon input from a User.

4. The printer controller of claim 1, wherein the printer controller is further caused to:
provide instructions to submit the hardcopy artifact for delivery to the Person.

5. The printer controller of claim 1, wherein the printer controller is further caused to:
generate an invoice based upon the hardcopy artifact generated and the address receiving a hard copy delivery.

6. The printer controller of claim 1, wherein the printer controller is further caused to:
generate a Digital Artifact including the template and the Contact Information and the Boundary related information.

7. The printer controller of claim 1, wherein the Geographic Area comprises a real estate parcel.

8. The printer controller of claim 1, wherein the Geospatial Designation is determined based upon receipt of a digital image and a GPS location captured with a mobile device.

9. The printer controller of claim 1, wherein the Geospatial Designation is determined based upon information captured with a mobile GPS device and a directional device.

10. The printer controller of claim 1, wherein the Geospatial Designation is determined based upon a User input referencing an image representation of the Geographic Area.

11. A method for generating hardcopy artifacts specific to a user designated geographic area, the method comprising:
receiving from a user interaction a selected point associated with a Geospatial Designation;
generating a selection of a polygon associated with a Geographic Area;
generating a Boundary for the polygon associated with the Geographic Area;
generating an association of the Boundary for the Geographic Area with a Person;
determining that the selected point is included within one of the polygon and the boundary;
designating a Person with contact information including at least an address for receiving a hard copy delivery;
accessing a storage of attributes related to the Geographic Area designated;
automatically associating with a controller at least one comparable real estate property;
accessing attributes descriptive of the at least one comparable real estate property;
accessing a pecuniary value associated with the at least one comparable real estate property; and
generating a comparative market analysis report comprising: a template for listing the attributes of the at least one comparable real estate property and respective pecuniary values for each comparable real estate property and a calculated value of the geographic area associated with the selected point.

12. The method of claim 11, additionally comprising the step of:
receiving an alphanumeric identifier of the template to be referenced in the generating of the hardcopy artifact.

13. The method of claim 11, additionally comprising the step of:
generating the template based upon input from a User.

14. The method of claim 11, additionally comprising the step of:
providing instructions to submit the hardcopy artifact for delivery to the Person.

15. The method of claim 11, additionally comprising the step of:
generating an invoice based upon the hardcopy artifact generated and the address receiving a hard copy delivery.

16. The method of claim 11, additionally comprising the step of: generating a Digital Artifact including the template and the Contact Information and the Boundary related information.

17. The method of claim 11, wherein the Geographic Area comprises multiple real estate parcels.

18. The method of claim 11, wherein the Geospatial Designation is determined based upon receipt of a digital image and a GPS location captured with a mobile device.

19. The method of claim 11, wherein the Geospatial Designation is determined based upon information captured with a mobile GPS device and a directional device.

20. The method of claim 11, wherein the Geographic Area comprises multiple real estate parcels and the Geospatial Designation is determined based upon at least one of: a User input referencing an image representation of the Geographic Area and information captured with a mobile GPS device and a directional device; and the method additionally comprises the steps of:
generating the template based upon input from a User;
providing instructions to submit the hardcopy artifact for delivery to the Person;
generating an invoice based upon the hardcopy artifact generated and the address receiving a hard copy delivery; and
generating a Digital Artifact including the template and the Contact Information and the Boundary related information.
